(19) United States
(12) Patent Application Publication
(10) Pub. No.: US 2023/0420898 A1
(43) Pub. Date: Dec. 28, 2023

(54) ELECTRICAL CONDUCTOR SPLICE DEVICES

(71) Applicant: Hubbell Incorporated, Shelton, CT (US)

(72) Inventors: Charles L York, III, Bow, NH (US); Spencer Phelan Ralphs, Stoneham, MA (US); Shane Michael Hopps, Whitefield, NH (US); Jefferson Robert Hall, Concord, NH (US)

(73) Assignee: Hubbell Incorporated, Shelton, CT (US)

(21) Appl. No.: 18/341,181

(22) Filed: Jun. 26, 2023

Related U.S. Application Data
(60) Provisional application No. 63/355,482, filed on Jun. 24, 2022.

(51) Int. Cl. H01R 31/02; H01R 4/52; H01R 13/639

(52) U.S. Cl. CPC H01R 31/02; H01R 13/648; H01R 13/639; H01R 4/52

(57) ABSTRACT

A splice device is provided that includes a main housing, a first set of jaws, and a movement conversion assembly. The first set of jaws is in the main housing and depend outward along a conductor axis. The first set of jaws receive a first electrical conductor therein. The movement conversion assembly is in the main housing and includes a driver operatively associated with the first set of jaws so that a tightening movement of the driver is converted into a clamping force of the first set of jaws on the first electrical conductor.

### CROSS REFERENCE TO RELATED APPLICATIONS

This application claims benefit of U.S. Provisional Application No. 63/355,482 filed Jun. 24, 2022, the entire contents of which are incorporated herein by reference.

### BACKGROUND

### 1. Field of the Invention

The present disclosure is related to splice devices for electrical conductors. More particularly, the present disclosure is related to splice devices for electrical conductors of the same or different outer diameter.

### 2. Description of Related Art

Automatic splice devices are known and have been found to be an economically attractive option for splicing electrical conductors. These automatic splice devices allow for connection of electrical conductors automatically, namely without the use of specialized tools. An example of such an automatic splice device is shown in Applicant's own U.S. Pat. No. 10,498,052.

However, such automatic splice devices can only make reliable electrical connections where there is a predetermined minimum amount of tension maintained on the conductors at all times. Simply stated, automatic splice devices cannot be used in “slack-span” applications—where little or no tension is applied to the conductors being joined. Moreover, automatic splice devices cannot reliably be used in applications where the predetermined minimum tension cannot be maintained due to vibration, wind, or other tension relieving conditions.

Conversely, splice devices are known for such slack-span applications but require specialized tools such as, but not limited, crimping tools and the like and require multiple components—which increase the time and cost to splice electrical conductors.

Accordingly, it has been determined by the present application there is a need for electrical conductor splicing devices that overcome, alleviate, and/or mitigate one or more of the aforementioned and other deleterious effects of the prior art.

### SUMMARY

A splice device is provided that includes a main housing, a first set of jaws, and a movement conversion assembly. The first set of jaws is in the main housing and depend outward along a conductor axis. The first set of jaws receive a first electrical conductor therein. The movement conversion assembly is in the main housing and includes a driver operatively associated with the first set of jaws so that a tightening movement of the driver is converted into a clamping force of the first set of jaws on the first electrical conductor.

In some embodiments either alone or together with any one or more of the aforementioned and/or after-mentioned embodiments, the splice device further includes a dead-end depending from the main housing.

In some embodiments either alone or together with any one or more of the aforementioned and/or after-mentioned embodiments, the splice device further includes a second set of jaws in the main housing and depending outward along the conductor axis. The movement conversion assembly is operatively associated with the second set of jaws so that the tightening movement of the driver is converted into a second clamping force of the second set of jaws on the second electrical conductor to mechanically and electrically connect the second electrical conductor.

In some embodiments either alone or together with any one or more of the aforementioned and/or after-mentioned embodiments, the main housing encloses the first set of jaws and the movement conversion assembly.

In some embodiments either alone or together with any one or more of the aforementioned and/or after-mentioned embodiments, the splice device further includes a gap between the driver and the main housing. The gap allows the movement conversion assembly to move along the conductor axis during the tightening movement of the driver so as to accommodate differences in diameter of the first electrical conductor.

In some embodiments either alone or together with any one or more of the aforementioned and/or after-mentioned embodiments, the splice device further includes a biasing member configured to provide an initial clamping force on the first set of jaws prior to the tightening movement of the driver.

A splice device is provided that includes a main housing, a first set of jaws, a second set of jaws, and a movement conversion assembly. The main housing includes a hub, a first leg, and a second leg. The first and second legs depend outward from the hub along a conductor axis. The first set of jaws is in the first leg and the second set of jaws is in the second leg. The first leg receives a first electrical conductor therein, while the second leg receives a second electrical conductor therein. The movement conversion assembly is in the hub and includes a driver. The movement conversion assembly is operatively associated with the first and second set of jaws to convert a tightening movement of the driver into linear outward movement of the first and second set of jaws along the conductor axis. The first and second legs each have an inner surface that interact with an outer surface of the first and second set of jaws, respectively, to convert the linear outward movement of the first and second set of jaws into a linear downward movement along the driver axis to impart a clamping force on the first and second electrical conductors to mechanically and electrically connect the first and second electrical conductors, respectively.

In some embodiments either alone or together with any one or more of the aforementioned and/or after-mentioned embodiments, the movement conversion assembly moves along the conductor axis during the tightening movement of the driver so as to accommodate differences in diameter of the first and second electrical conductors.

In some embodiments either alone or together with any one or more of the aforementioned and/or after-mentioned embodiments, the first and second set of jaws move along the conductor axis independent of one another or in unison.

In some embodiments either alone or together with any one or more of the aforementioned and/or after-mentioned embodiments, the splice device further includes a gap between the movement conversion assembly and the main housing. The gap allows the movement conversion assembly to move along the conductor axis during the tightening movement of the driver so as to accommodate differences in diameter of the first and second electrical conductors.

In some embodiments either alone or together with any one or more of the aforementioned and/or after-mentioned embodiments, the movement conversion assembly includes a driving wedge, a first ram, and a second ram that are configured to convert a tightening movement of the driver into the linear outward movement of the first and second rams along the conductor axis. The linear outward movement of the first ram along the conductor axis results in linear outward movement of the first set of jaws, while the linear outward movement of the second ram along the conductor axis results in linear outward movement of the second set of jaws.

In some embodiments either alone or together with any one or more of the aforementioned and/or after-mentioned embodiments, the splice device further includes a first biasing member positioned between the first ram and the first set of jaws and a second biasing member positioned between the second ram and the second set of jaws.

In some embodiments either alone or together with any one or more of the aforementioned and/or after-mentioned embodiments, the first and second biasing members provide an initial clamping force on the first and second set of jaws prior to the tightening movement of the driver.

In some embodiments either alone or together with any one or more of the aforementioned and/or after-mentioned embodiments, the movement conversion assembly mechanically and electrically connects the first and second conductors when the first and second conductors have a common outer diameter or different outer diameters.

In some embodiments either alone or together with any one or more of the aforementioned and/or after-mentioned embodiments, the movement conversion assembly moves along the conductor axis during the tightening movement of the driver so as to accommodate differences in diameter of the first and second electrical conductors.

In some embodiments either alone or together with any one or more of the aforementioned and/or after-mentioned embodiments, the movement conversion assembly mechanically and electrically connects the first and second conductors when the first and second conductors are under tension.

In some embodiments either alone or together with any one or more of the aforementioned and/or after-mentioned embodiments, the movement conversion assembly mechanically and electrically connect the first and second conductors when the first and second conductors are not under tension.

In some embodiments either alone or together with any one or more of the aforementioned and/or after-mentioned embodiments, the driver further includes a torque limiting area that shears off a portion of the driver at a desired torque to ensure the clamping force has been applied to the first and second electrical conductors.

In some embodiments either alone or together with any one or more of the aforementioned and/or after-mentioned embodiments, the movement conversion assembly further includes driver retaining structures on opposite sides of the main housing. The driver retaining structures allow the driver to rotate within the main housing about the driver axis D_{A}, but to prevent the driver from moving linearly along the driver axis D_{A}.

In some embodiments either alone or together with any one or more of the aforementioned and/or after-mentioned embodiments, the first set of jaws have a first window that provides a visual confirmation of a position of the first electrical conductor within the first set of jaws and/or the second set of jaws have a second window that provides a visual confirmation of a position of the second electrical conductor within the second set of jaws.

In some embodiments either alone or together with any one or more of the aforementioned and/or after-mentioned embodiments, the first set of jaws have a first conductor stop that provides a tactile indication of a position of the first electrical conductor within the first set of jaws and/or the second set of jaws have a second conductor stop that provides a tactile indication of a position of the second electrical conductor within the second set of jaws.

The above-described and other features and advantages of the present disclosure will be appreciated and understood by those skilled in the art from the following detailed description, drawings, and appended claims.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a top perspective view of an exemplary embodiment of an electrical conductor splice device according to the present disclosure;

FIG. 2 is a sectional view of the device of FIG. 1 before installation on electrical conductors;

FIG. 3 is a sectional view of the device of FIG. 2 after installation on similarly sized electrical conductors and before tightening;

FIG. 4 is a sectional view of the device of FIG. 3 after tightening;

FIG. 5 is a sectional view of the device of FIG. 3 after installation on different sized electrical conductors and after tightening;

FIG. 6 is a partial side view of the device of FIG. 4 illustrating the viewing window;

FIG. 7 is a perspective view of a jaw portion of the device of FIG. 1;

FIG. 8 is a schematic view of an alternate embodiment of a movement conversion assembly according to the present disclosure;

FIG. 9 is perspective view of an alternate embodiment of an electrical conductor splice device according to the present disclosure;

FIG. 10 is a sectional view of the device of FIG. 9;

FIG. 11 is a sectional view of an alternate embodiment of an electrical conductor splice device according to the present disclosure after installation of similarly sized electrical conductors and before tightening;

FIG. 12 is a sectional view of the device of FIG. 11 after tightening;

FIG. 13 is a sectional view of an alternate embodiment of an electrical conductor splice device according to the present disclosure after installation of similarly sized electrical conductors and before tightening;

FIG. 14 is perspective view of an alternate embodiment of an electrical conductor splice device according to the present disclosure;

FIG. 15a is a sectional view of the device of FIG. 14;

FIG. 15b is a sectional view of an alternate embodiment of the device of FIG. 14;

FIG. 15c is a perspective view of the device of FIG. 15b;

FIG. 16 is perspective view of another alternate embodiment of an electrical conductor splice device according to the present disclosure;

FIG. 17 is a side view of the splice device of FIG. 16;

FIG. 18 is a first perspective view of a main housing of the splice device of FIG. 16;

FIG. 19 is a second perspective view of the main housing of FIG. 16;

FIG. 20 is a top perspective view of a jaw of the splice device of FIG. 16;

FIG. 21 is a bottom perspective view of the jaw of FIG. 16;

FIG. 22 is a perspective view of a first assembly step for the splice device of FIG. 16;

FIGS. 23a and 23b are perspective views of a second assembly step for the splice device of FIG. 16;

FIGS. 24a and 24b are perspective views of a third assembly step for the splice device of FIG. 16;

FIGS. 25a and 25b are perspective views of a forth assembly step for the splice device of FIG. 16;

FIG. 26 is perspective view of another alternate embodiment of an electrical conductor splice device according to the present disclosure;

FIG. 27 is a side view of the splice device of FIG. 26;

FIGS. 28a, 28b, and 28c illustrate a driver of the splice device of FIG. 26;

FIG. 29 is a perspective view of another alternate embodiment of an electrical conductor splice device according to the present disclosure;

FIG. 30 is an exploded view of the splice device of FIG. 29;

FIG. 31 is a comparison of the horizontally arranged main housing of the splice device of FIG. 29 and a vertically arranged main housing;

FIG. 32 is a perspective view of another alternate embodiment of an electrical conductor splice device according to the present disclosure;

FIG. 33 is a sectional view of the splice device of FIG. 32; and

FIG. 34 is an enlarged view of FIG. 33.

### DETAILED DESCRIPTION

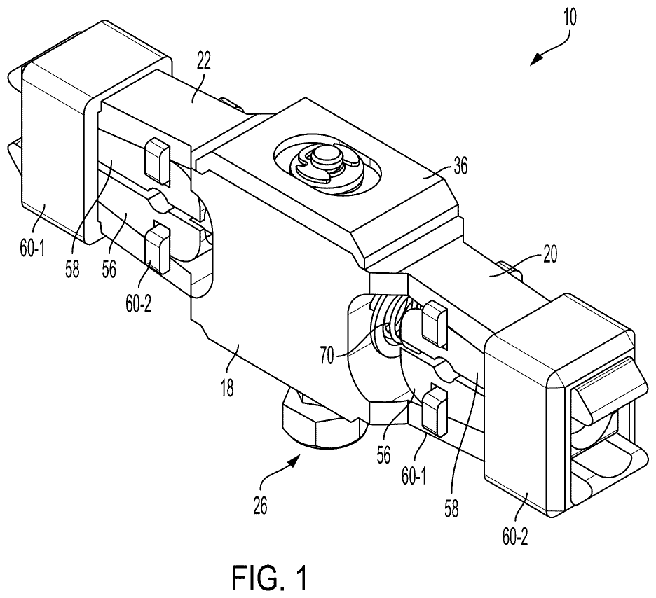

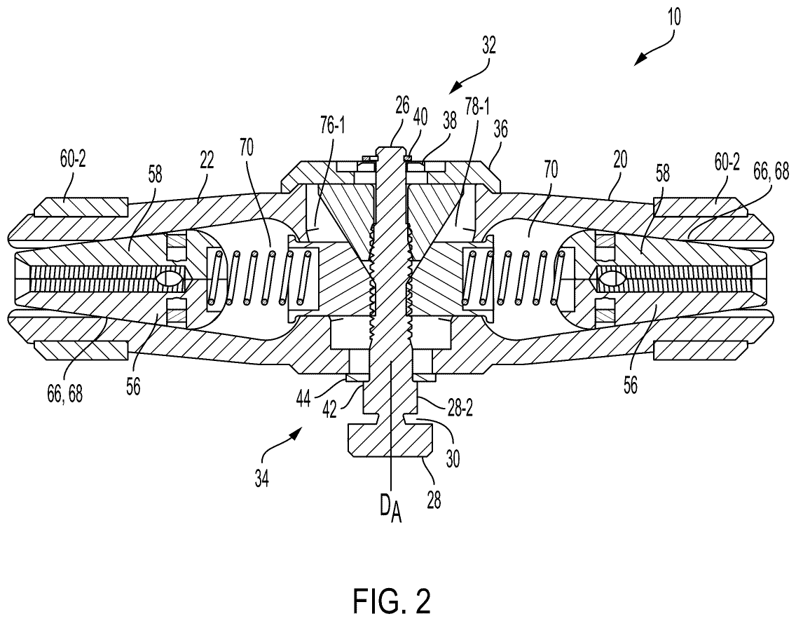

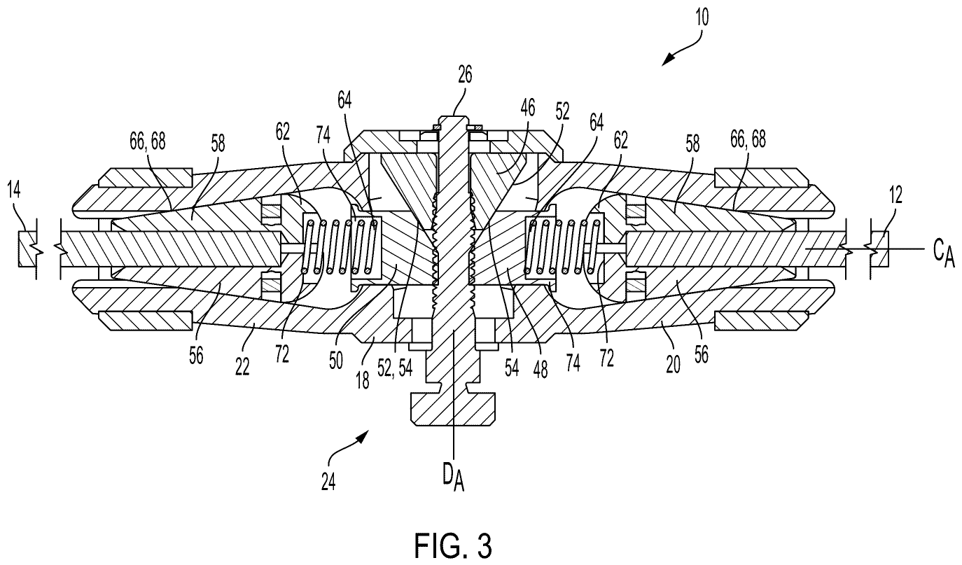

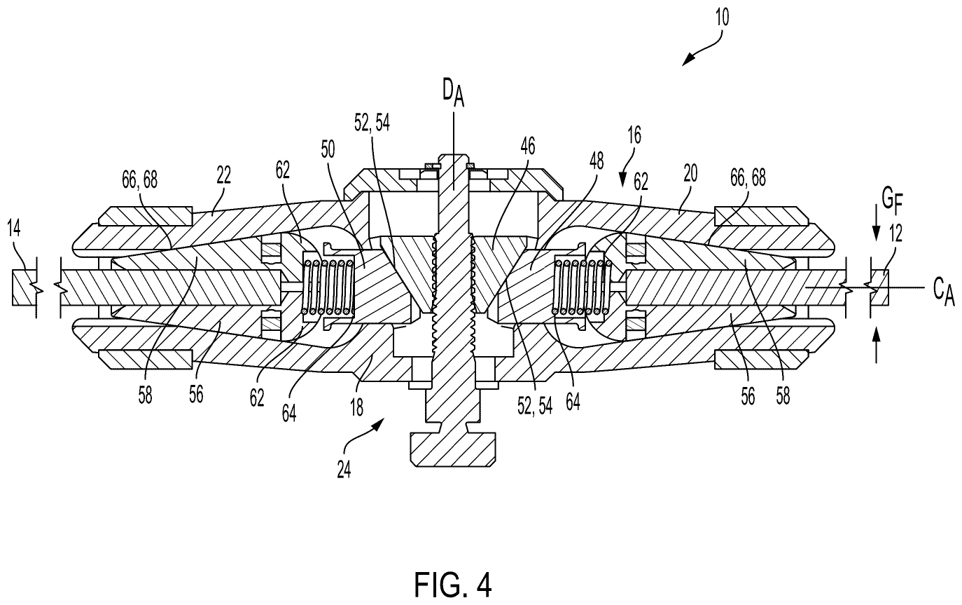

Referring to the drawings and in particular with simultaneous reference to FIGS. 1-5, an exemplary embodiment of an electrical conductor splice device according to the present disclosure is shown and is generally referred to by reference numeral 10.

Advantageously, device 10 can be used to mechanically and electrically connect conductors 12, 14 that are under tension or that have little or no tension applied to the conductors—so called slack-span conductors. Device 10 can be installed on electrical conductors 12, 14 using common tightening tools such as, but not limited to, open-end wrenches, boxed-end wrenches, adjustable wrenches, manual socket wrenches, and impact wrenches.

Moreover and in some embodiments, device 10 can be configured to self-adjust to connect electrical conductors 12, 14 of different sizes (i.e., outer diameter or OD). In this manner, device 10 can be configured for electrical conductor reducing applications.

Device 10 has a main housing 16 that includes a hub 18 and a pair of legs 20, 22 that depend outward from the hub at about 180 degrees from one another. In some embodiments, housing 16 is formed as a single aluminum member with hub 18 and legs 20, 22 integral thereto.

As can be seen, device 10 advantageously has an open architecture that allows water and contamination to drain to mitigate the formation of corrosion.

Main housing 16 receives a movement conversion assembly 24 within hub 18. Assembly 24 is configured to convert a tightening movement of a driver 26, which is illustrated by way of example as a bolt, into a clamping force C_{F} on conductors 12, 14. In some embodiments, assembly 24 is configured with one or more degrees of freedom sufficient to accommodate conductors 12, 14 of differing outer diameters. In still other embodiments, assembly 24 is configured to hold conductors 12, 14 in position during the tightening movement of the driver.

Assembly 24 includes driver 26, which can be any torque receiving structure. For example, driver 26 is illustrated as a bolt with a head 28, positioned so that application of a tightening torque to the driver via the head rotates the driver about a driver axis D_{A}. In some embodiments, driver 26 includes a torque limiting area 30 that shears off head 28 once an appropriate level of torque and, thus clamping force, has been applied to device 10.

While driver 26 is illustrating having head 28 for receiving the application of the tightening movement, the present disclosure contemplates driver 26 having any torque receiving structure such as but not limited to flat head drives, Phillips drives, hex drives, Torx drives, square drives openings, and others.

Assembly 24 includes driver retaining structures 32, 34 on opposite sides of housing 16 that allows driver 26 to rotate within housing 16 about driver axis D_{A}, but prevents the driver from moving linearly along the driver axis D_{A}.

In the illustrated embodiment, driver retaining structure 32 on the side of housing 16 opposite head 28 is illustrated as a cap 36 on housing, a washer or bushing 38 on the cap, and a snap ring 40 on driver 26. It should be recognized that retaining structure 32 is illustrated by way of example only as including cap 36, bushing 38, and snap ring 40. Of course, other retaining structures 32 are contemplated by the present disclosure. For example, retaining structure 32 can include any desired structure sufficient to allow driver 26 to rotate without movement along the driver axis D_{A} and can include structures such as, but not limited to, cotter pins, split pins, a peened end of driver 26, and others.

In the illustrated embodiment, retaining structure 34 on the side of housing 16 proximate head 28 is illustrated as shoulder 42 defined on driver 26 and washer or bushing 44 between hub 18 and the shoulder. In some embodiments, shoulder 42 can be configured as a second head 28-2. For example, when driver 26 includes torque limiting area 30 that shears off head 28, second head 28-2 can remain after shearing so that device 10 can be loosened or removed after an initial installation.

Accordingly, assembly 24 is configured to allow driver 26 to rotate within housing 16 about driver axis D_{A} but prevent the driver from moving linearly along the driver axis D_{A}.

Assembly 24 further includes a driving wedge 46 and a ram 48, 50 in each leg 20, 22.

Driving wedge 46 is threadably engaged with driver 26. Thus, assembly 24 is configured so that wedge 46 moves within hub 18 linearly along driver axis D_{A} during rotation of driver 26.

Driving wedge 46 includes an angled driving surface 52. Rams 48, 50 each have an angled driven surface 54 that are in operative contact with the driving surface. In this manner, the movement of wedge 46 linearly along driver axis D_{A} is converted, by the interaction of surfaces 52, 54 with one another, into movement of rams 48, 50 linearly outward along a conductor axis C_{A}.

Assembly 24 can include one or more jaws (two shown) 56, 58 in each leg 20, 22.

Jaws 56, 58 are configured to move linearly along conductor axis C_{A} and are retained by one or more jaw retainers 60-1, 60-2 that retain the jaws in each leg 20, 22, respectively while allowing the jaws to move along the conductor axis C_{A}. Jaws 56, 58 can move in unison along conductor axis C_{A} such as when conductors 12, 14 have the same outer diameter and can move independent from one another along the conductor axis C_{A} such as when conductors 12, 14 have differing outer diameters.

In some embodiments, retainers 60-1 are positioned around an outside of legs 20, 22 and are positioned on the legs remote from hub 18. In this manner, retainers 60-1 provide strength to legs 20, 22 so as to prevent the legs from deflecting outward and away from conductors 12, 14 when device 10 is tightened via assembly 24. During assembly of device, retainers 60-1 can be pushed over legs 20, 22 such that the legs deflect inward and return to position once the retainers reach a predefined position along the conductor axis C_{A} at which point the legs elastically return outward with the retainers maintained in position with interaction of a lip or edge on the legs.

Jaws 56, 58 together define a pushed surface 62 that is operatively coupled to a pushing surface 64 of each ram 48, 50. In this manner, assembly 24 ensures—via interaction of pushed and pushing surfaces 62, 64—that movement of rams 48, 50 linearly outward along conductor axis C_{A} results in movement of jaws 56, 58 linearly outward along the conductor axis C_{A}.

Legs 20, 22 have an inner surface 66 and jaws 56, 58 have an outer surface 68 that interact with one another to convert the linear outward movement of the jaws along conductor axis C_{A} into linear movement along driver axis D_{A} towards conductors 12, 14, respectively. The movement of jaws 56, 58 towards conductors 12, 14 along driver axis D_{A} results in the jaws applying clamping force C_{F} on the conductors.

Simply stated, rotation of driver 26 causes driving wedge 46 to urge rams 48, 50 linearly outward—which in turn urges jaws 56, 58 linearly outward—which in turn compresses the jaws inward onto conductors 12, 14.

Device 10 is disclosed by way of example only as having driver 26 configured as a bolt that is threadably engaged with driving wedge 46 such that the tightening movement is a rotary movement about driver axis D_{A}. Of course, it is contemplated by the present disclosure for driver 26 to have cam lobes that act, upon rotation of the driver, directly and/or indirectly on jaws 56, 58 without threaded engagement.

Further, device 10 is disclosed by way of example only having driver 26 positioned so that driver axis D_{A} has a vertical orientation. Of course, it is contemplated by the present disclosure for device 10 to be configured so that driver axis D_{A} has any desired orientation such as, but not limited to, a horizontal orientation.

Still further, device 10 is disclosed by way of example only having driver 26 configured so that the tightening movement is a rotary movement about the driver axis D_{A}. Of course, it is contemplated by the present disclosure for device 10 to be configured so that the tightening movement is a linear movement along the driver axis D_{A}—for example by pressing or compressing of driver 26 into the device.

In some embodiments, device 10 includes a biasing member 70 disposed between rams 48, 50 and jaws 56, 58. Here, pushed surface 62 can define a first spring land 72 and pushing surface 64 can define a second spring land 74. Biasing member 70 is captured by lands 72, 74 and provides a first degree of freedom that allows device 10 to accommodate conductors 12, 14 of differing outer diameters.

The first degree of freedom of device 10 allows for jaw 56 to move linearly outward along conductor axis C_{A} a different distance than jaw 58 moves for the same amount of rotation of driver 26. In this manner, device 10 allows for jaws 56, 58 to move different distances along driver axis D_{A} depending on the outer diameter of conductors 12, 14, respectively.

Biasing member 70 can be made of any electrically conductive or insulating material that applies a spring force between lands 72, 74. In the illustrated embodiment, biasing member 70 is shown as a compression spring that is made of a metallic material such as, but not limited to, stainless steel.

It has been further found by the present disclosure that biasing member 70 can aid in assembly of device 10 and conductors 12, 14. Here, biasing member 70 can provide an initial clamping force C_{F} on jaws 56, 58 prior to tightening of assembly 24. Thus, the user only needs to install conductors 12, 14 into device 10—with biasing members 70 temporarily holding the conductors in place—while the user tightens assembly 24 by using a tool on head 28.

In some embodiments, device 10 includes a first gap 76 between driver 26 and housing 16—and a second gap 78 between the driver and cap 36. Gaps 76, 78 can provide a second degree of freedom that allows device 10 to accommodate conductors 12, 14 of differing outer diameters.

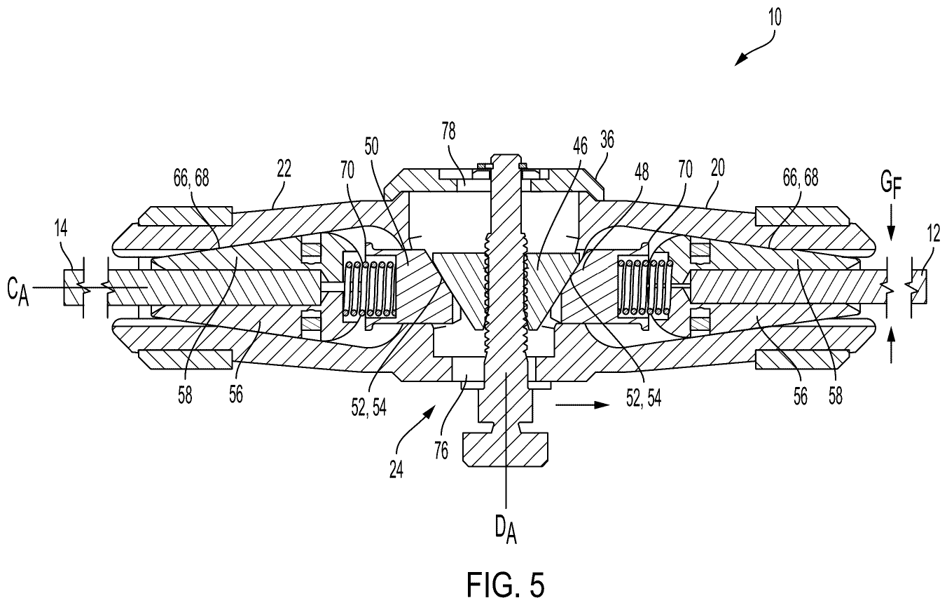

The second degree of freedom of device 10 provides clearance such that conversion assembly 24 can move within hub 18 along conductor axis C_{A} depending on the outer diameter of conductors 12, 14, respectively. Movement of assembly 24 can be seen in FIG. 5 where conductor 12 has a smaller outer diameter than conductor 14. Here, it can be seen that assembly 24 (e.g., driver 26 and driving wedge 46) has moved along conductor axis C_{A} towards the smaller conductor 12—namely towards the left side of FIG. 5.

In some embodiments, the second degree of freedom results in assembly 24 moving off center towards the smaller conductor, which ensures jaws 56, 58 move linearly outward along conductor axis C_{A} the same distance as one another.

In embodiments where device includes both the first and second degrees of freedom (i.e., biasing member 70 and gaps 76, 78) not only accommodates conductors 12, 14 of differing outer diameters but does so while balancing the clamping force C_{F} on both conductors to be substantially equal to one another.

It should be recognized that device 10 is described above as providing second degree of freedom so as to accommodate conductors 12, 14 of differing outer diameters. Of course, it is contemplated by the present disclosure for device 10 to have other structures that provide the aforementioned second degree of freedom. For example, it is contemplated for device 10 to have a first gap 76-1 and a second gap 78-1 between one or more components of movement conversion assembly 24 and housing 16 where these gaps either combined with or independent from retaining structures 32 provide the aforementioned second degree of freedom.

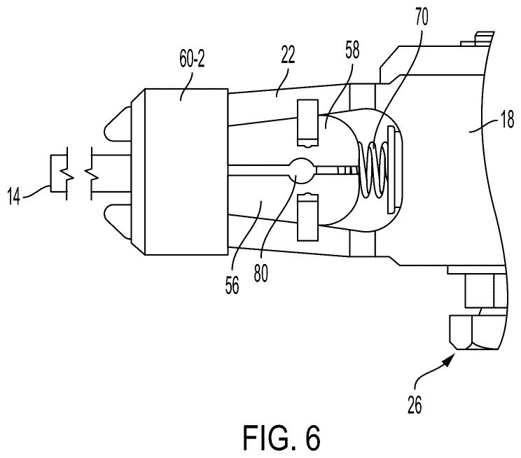

In some embodiments, jaws 56, 58 alone or in combination with one another are configured to define a window 80 in each leg as shown in FIG. 6. When installing conductors 12, 14 into device 10, window 80 provides the user with a visual indication that the conductors are properly positioned within jaws 56, 58—without previously measuring and marking the conductor ends.

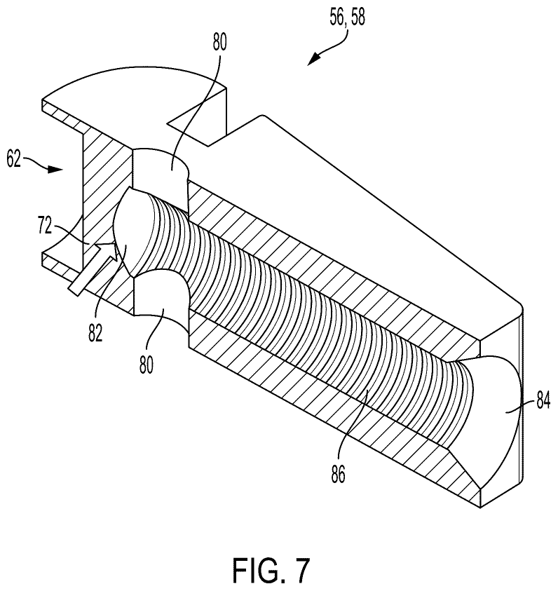

In some embodiments, jaws 56, 58 alone or in combination with one another are configured to define a stop 82 in each leg as shown in FIG. 7. When installing conductors 12, 14 into device 10, stop 82 provides the user with a tactile indication that the conductors are properly positioned within jaws 56, 58

In embodiments where jaws 56, 58 have window 80 and stop 82, the window is positioned at least adjacent to or overlapping the stop to allow the visual indication of the conductors contacting the stop.

In some embodiments, jaws 56, 58 alone or in combination with one another are configured to define a chamfered edge 84 as also shown in FIG. 7. When installing conductors 12, 14 into device 10, chamfered edge 84 provides the user with a guide that aids in insertion of the conductors into jaws 56, 58.

In some embodiments, jaws 56, 58 alone or in combination with one another are configured to define a gripping edges 86 as also shown in FIG. 7. Edge 86 can ensure that jaws 56, 58 bite or grip into conductors 12, 14 once installed.

It should be recognized that device 10 is described by way of example using angled surfaces 52, 54 to convert the rotational movement of driver 26 into the linear outward movement of rams 48, 50. Of course, it is contemplated by the present disclosure for device 10 to have any combination of rotary motion conversion elements sufficient to convert the rotary motion of driver 26 into the linear outward movement of rams 48, 50. For example, device 10 can include rotary motion conversion elements, such as but not limited to, corresponding cam and follower surfaces, gear trains, rack and pinion structures, scissor or toggle clamps, and the like.

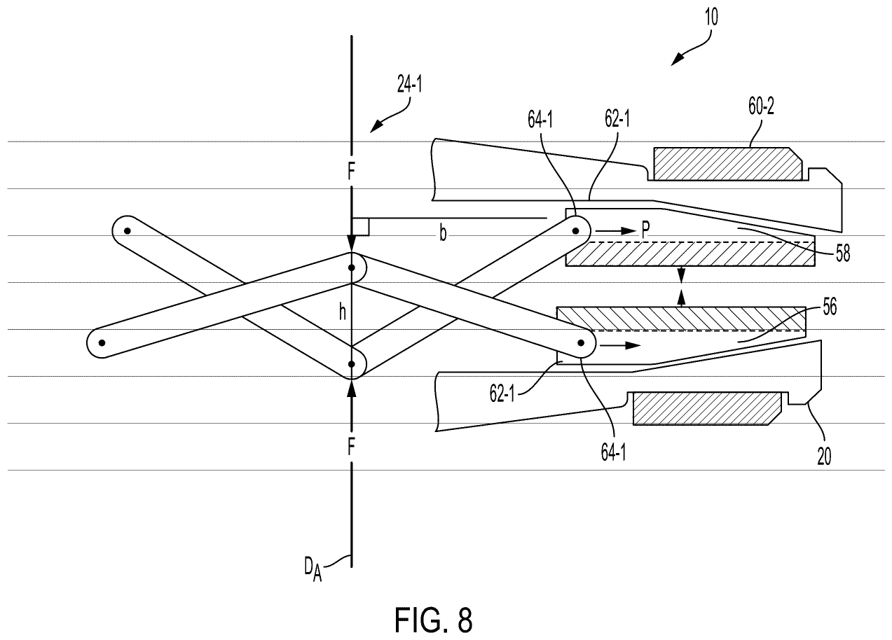

By way of example, an exemplary embodiment of an alternate embodiment of movement conversion assembly 24-1 of device 10 is shown in FIG. 8 as a scissor or toggle clamp. Clamp 24-1 has a plurality of arms operative to convert rotational movement about driver axis D_{A} to linear movement along conductor axis C_{A}. Here, clamp 24-1 includes a pushing surface 64-1 that is operatively coupled to a pushed surface 62-1 of jaws 56, 58—eliminating rams of the aforementioned embodiments.

Simply stated, it is contemplated by the present disclosure for device 10 to have combination of elements sufficient to provide a movement conversion assembly—that convert the rotational movement of driver 26 into the linear outward movement of jaws 56, 58.

It should be recognized that device 10 is described by way of example having main housing 16 configured with legs 20, 22 depending from hub 18 aligned 180 degrees from one another. However, it is contemplated by the present disclosure for device 10 to be configured to connect the electrical conductors at any desired angle between 90 and 180 degrees—with legs 22 depending from hub 18 at any desired angle between 90 and 180 degrees.

It should be recognized that device 10 is described by way of example connecting two electrical conductors 12, 14. Specifically, device 10 is shown having two legs 20, 22 depending from hub 16. However, it is contemplated by the present disclosure for device 10 to be configured to connect more or less than two electrical conductors, such as but not limited to, between one and six conductors, with between one and four conductors being more preferred. Thus in these embodiments, device 10 can have between one and six legs disposed about the hub—where the legs can be angled with respect to one another at any desired angle.

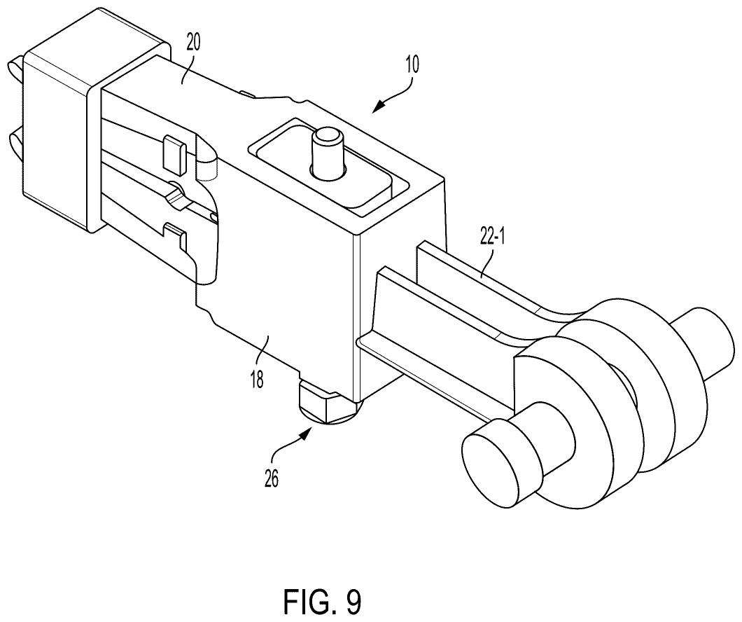

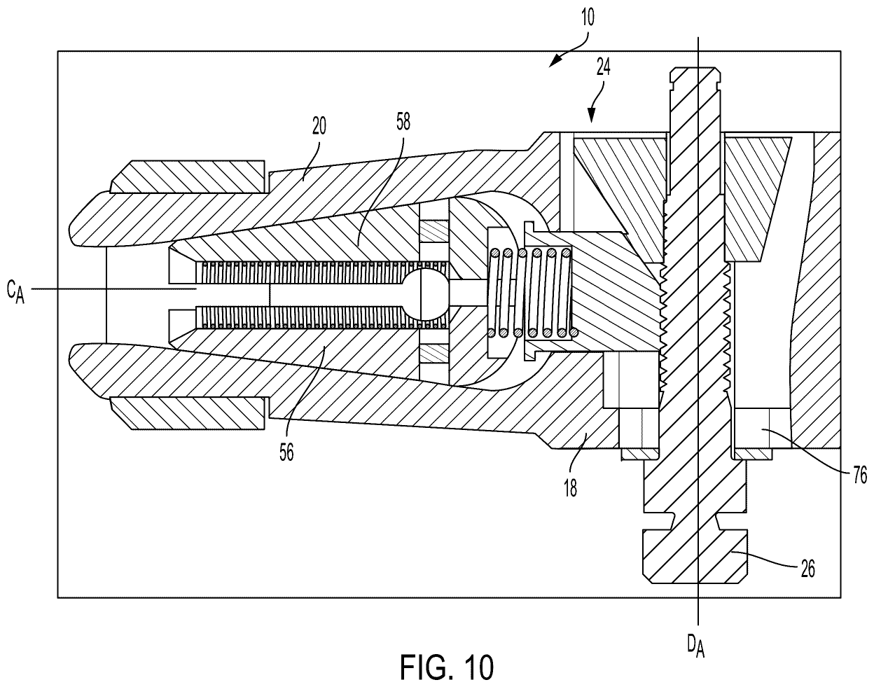

An exemplary embodiment of device 10 is shown in FIGS. 9-10. Here, device 10 has hub 18 with one leg 20 configured for connection to an electrical conductor (not shown) and a second leg 22-1 configured as a dead-end. Hub 18 includes movement conversion assembly 24 with driver 26 and jaws 56, 58 as discussed in detail above.

As discussed above with respect to FIG. 5, device 10 can include first gap 76 between driver 26 and housing 16—and second gap (not shown) between the driver and cap (not shown). The gaps provide freedom that allows device 10 to accommodate conductors of differing outer diameters in first leg 20.

Second leg 22-1, which is configured as a dead-end, is known in the art as being configured to form a connection between device 10 and, for example, a pole or structure. Further, second leg 22-1, which is configured as a dead-end, is known in the art as being configured for use when conductor axis C_{A} is being changed by a large amount. Thus, device 10, when configured with second leg 22-1 as dead-end, can be installed at the start and/or end of a placement of an electrical conductor.

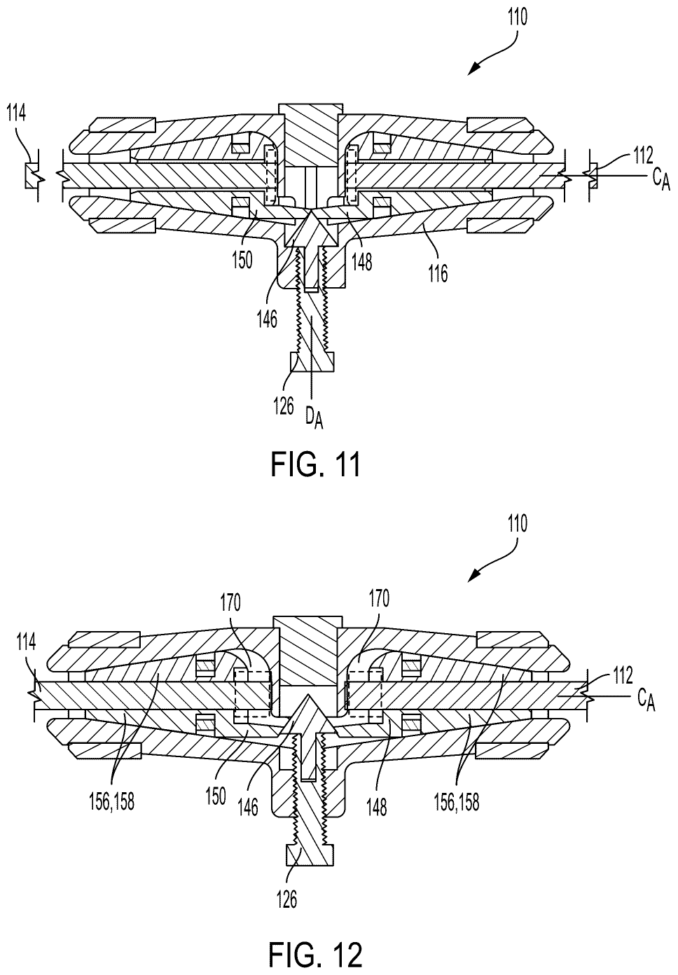

Referring now to FIGS. 11-12, an alternate embodiment of an electrical conductor splice device according to the present disclosure is shown and is generally referred to by reference numeral 110. Device 110 has a simplified structure as compared to device 10 such that discussion of certain parts performing similar or analogous functions to those of device 10 have been omitted.

Device 110 is configured to electrically and mechanically connect conductors 112, 114 to one another. Device 110 includes rams 148, 150 and jaws 156, 158 that are integral with one another. Further, device 110 includes driver 126 having a driving wedge 146 integral therewith. In this embodiment, housing 116 is threadably engaged with driver 126 such that rotation of the driver about driver axis D_{A} results in driving wedge 146 moving linearly along the driver axis so as to urge the integral rams and jaws outward along the conductor axis C_{A}.

In some embodiments, device 110 includes a biasing member 170 positioned between jaws 156, 158 and housing 116.

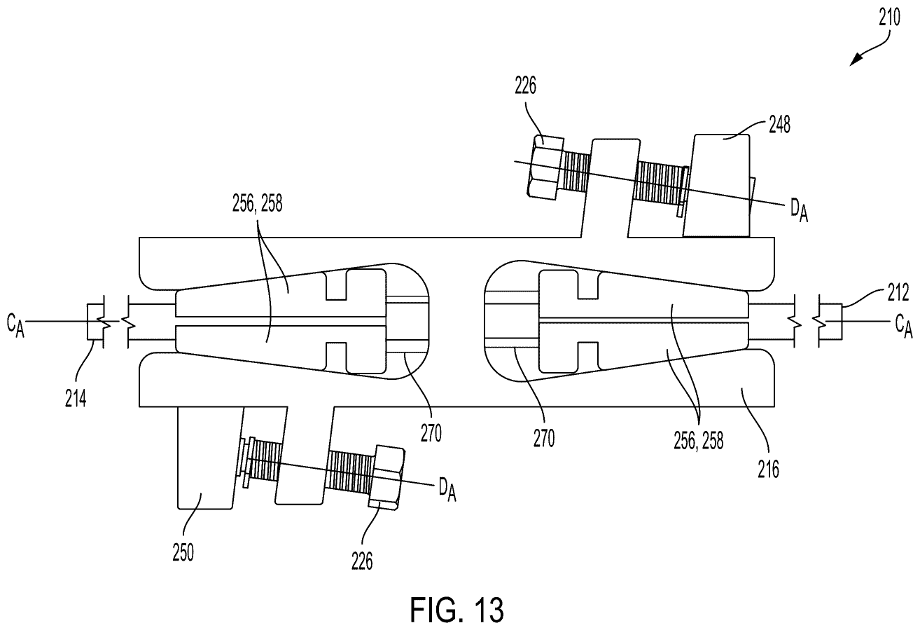

Referring now to FIG. 13, another alternate embodiment of an electrical conductor splice device according to the present disclosure is shown and is generally referred to by reference numeral 210. Discussion of certain parts of device 210 that perform similar or analogous functions to those of devices 10, 110, have been omitted.

Device 210 is configured to electrically and mechanically connect conductors 212, 214 to one another. Device 210 also includes rams 248, 250 and jaws 256, 258 that are integral with one another. Further, device 210 includes two drivers 226, which are both shown as bolts, operatively engaged with rams 248, 250, respectively. In this embodiment, housing 216 is threadably engaged with drivers 226 such that rotation of the driver about driver axis D_{A} results in rams 248 moving linearly along the conductor axis C_{A} so as to urge the integral rams and jaws outward along the conductor axis C_{A}.

Here, the need for the degrees of freedom discussed above with respect to device are eliminated by inclusion of two drivers 226 that can be tightened different amounts. In some embodiments, device 210 includes a biasing member 270 positioned between jaws 256, 258 and housing 216 as shown—or positioned between rams 248, 250 and the housing.

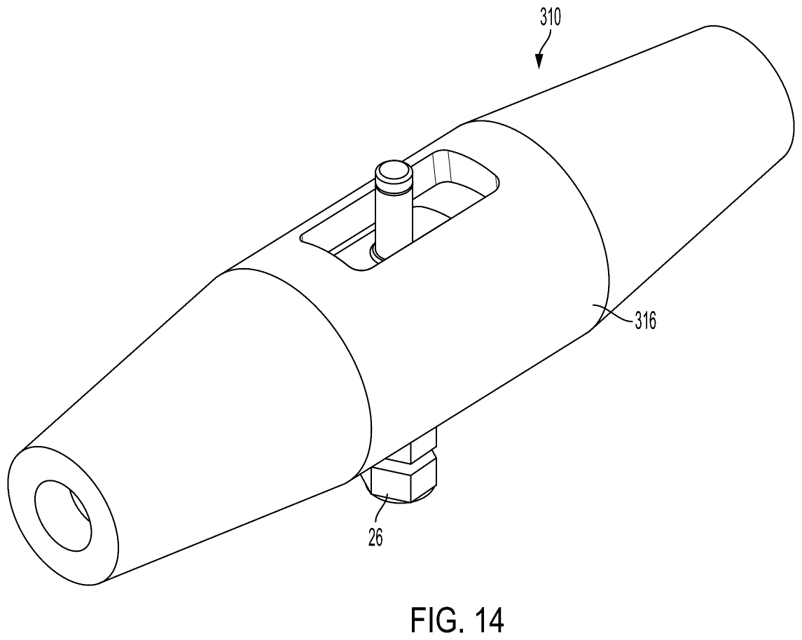

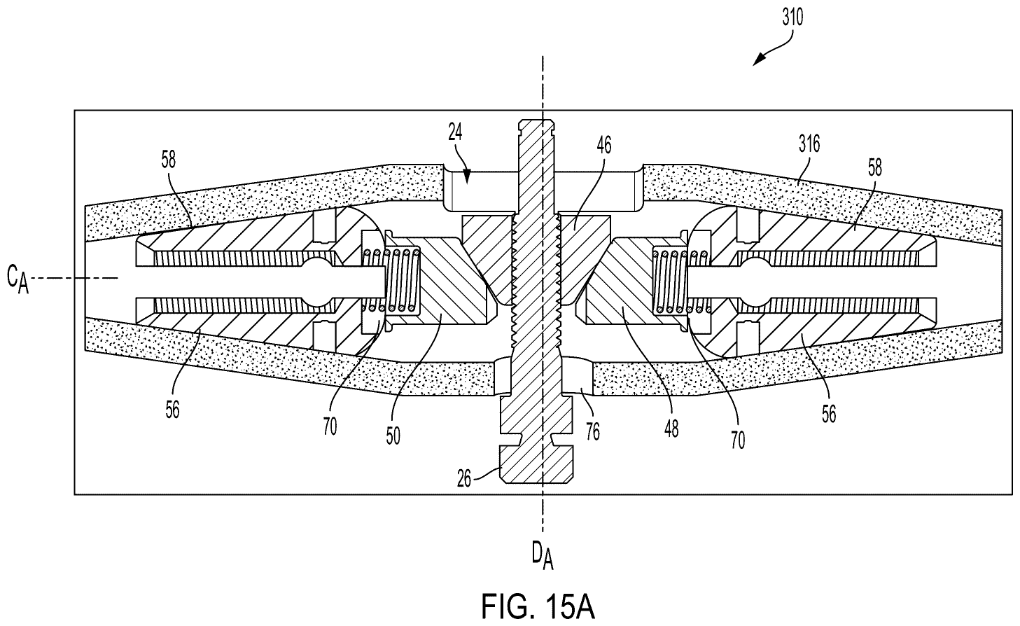

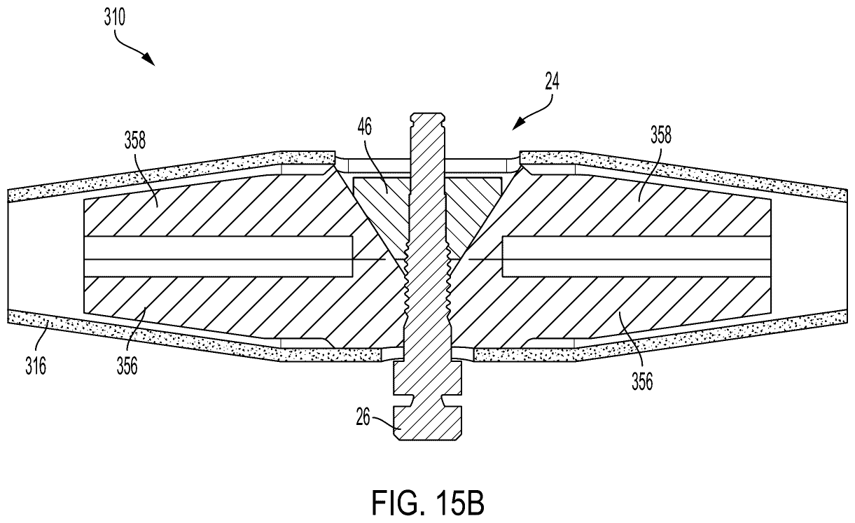

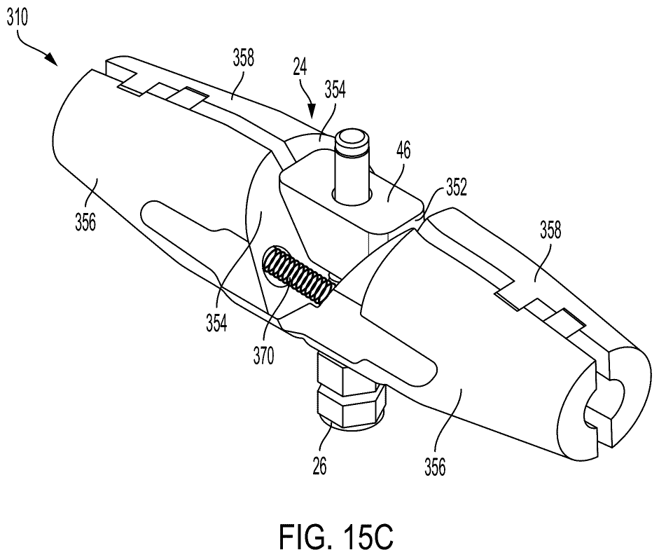

Referring now to FIGS. 14 and 15a, another alternate embodiment of an electrical conductor splice device according to the present disclosure is shown and is generally referred to by reference numeral 310. Device 310 has a simplified structure as compared to devices 10, 110, 210 such that discussion of certain parts performing similar or analogous functions have been omitted.

Device 310 is configured as an enclosed splice device having an outer housing 316 that takes the place of the main housing 16, the hub 18, the legs 20, 22, and the jaw retainers 60-2. Rather, device 310 includes movement conversion assembly 24, driver 26, driving wedge 46, rams 48, 50, jaws 58, 60, and biasing member 70 contained within housing 316. Outer housing 316 encloses or shields the components of device 310 from weather and environmental impacts.

As discussed above with respect to FIG. 5, device 310 can include first gap 76 between driver 26 and housing 316—and second gap (not shown) between the driver and cap (not shown). The gaps provide freedom that allows device 310 to accommodate conductors of differing outer diameters.

Housing 316 can be formed in multiple sections that are connected to one another in any desired manner such as, but not limited to, mechanical connection, thermal connection, adhesive connection, and others. Additionally, housing 316 can be formed as a unitary hollow element that has one or more regions compressed around components of device 310. For example and as shown in the illustrated embodiment, housing 316 has ends that are swaged around the components of device 310.

As illustrated in FIGS. 15b-15c, it is contemplated by the present disclosure for movement conversion assembly 24 to be simplified in some embodiments by, for example, forming jaws 358, 360 integrally in one-piece with the rams. Here, jaws 358, 360 have been rotated with respect to driver 26 so that each jaw 358, 360 has a continuous angled surface 354 in contact with the angled surfaces 352 of wedge 46, respectively. The rotation of jaws 358, 360 allows a single casting to be used for these components.

In embodiments having the integrally formed jaws 358, 360 and the rams, biasing member 370 can be moved outward of driver 26. In some instances, device 310 includes two biasing member 370, one on either side of driver 26.

In some embodiments, biasing member 370 can be omitted to further simplify device 310.

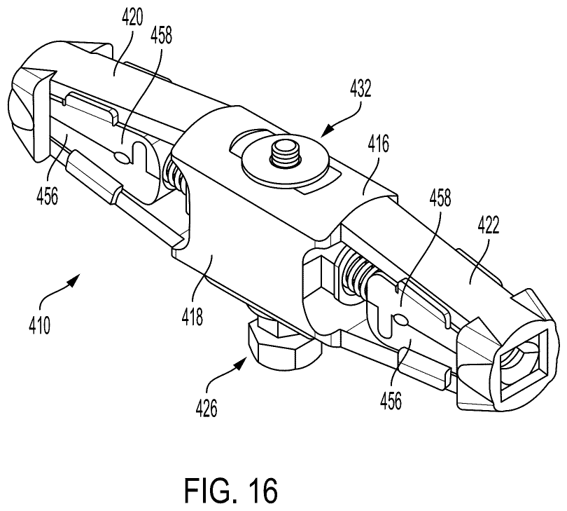

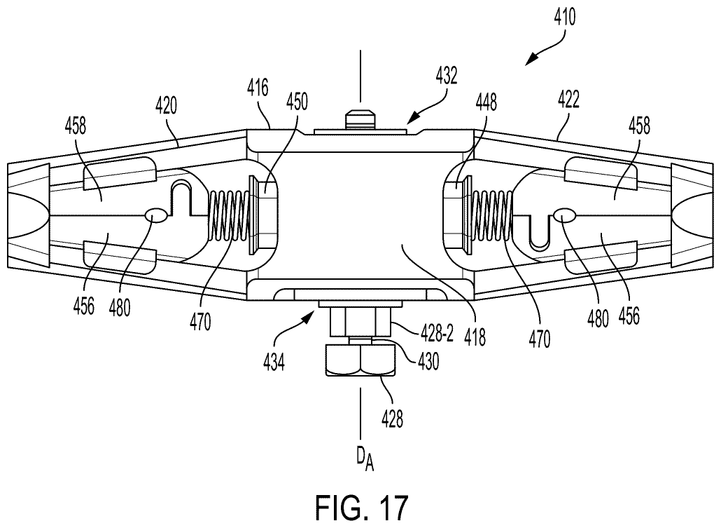

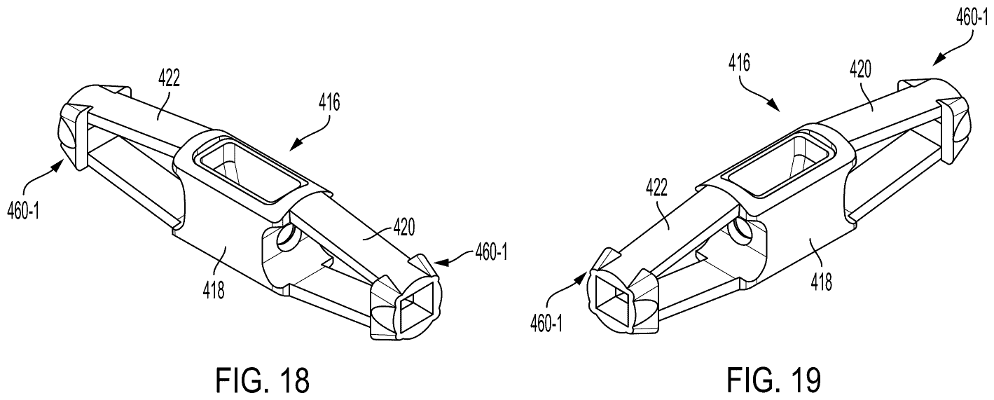

Referring now to FIGS. 16-25b, an alternate embodiment of an electrical conductor splice device according to the present disclosure is shown and is generally referred to by reference numeral 410.

Device 410 is configured to electrically and mechanically connect electrical conductors to one another where the conductors are under tension or that have little or no tension applied to the conductors—so called slack-span conductors. Device 410 can be installed on the electrical conductors using common tightening tools such as, but not limited to, open-end wrenches, boxed-end wrenches, adjustable wrenches, manual socket wrenches, and impact wrenches.

Device 410 has a main housing 416 that includes a hub 418 and a pair of legs 420, 422 that depend outward from the hub at about 180 degrees from one another. In some embodiments, housing 416 is formed as a single aluminum member with hub 418 and legs 420, 422 integral thereto. For example, device 410 can, in some cases, be formed as an aluminum casting that requires no post casting machining.

In some embodiments, main housing 416 can include structural features 460-1 positioned around an outside of legs 420, 422 remote from hub 418. Features retainers 460-1 can provide strength to legs 420, 422 to prevent the legs from deflecting outward and away from conductors when device 410 is tightened via a movement conversion assembly 424.

Main housing 416 receives a movement conversion assembly 424 within hub 418. Assembly 424 is configured to convert a tightening movement of a driver 426, which is illustrated by way of example as a bolt, into a clamping force on the conductors in the manner described in detail above with respect to device 10. Thus, certain parts performing similar or analogous functions to those of device 10 have been omitted for ease of discussion.

Driver 426, which is illustrated as a bolt with a head 428, is positioned so that application of a tightening torque to the driver via the head rotates the driver about a driver axis D_{A}. In some embodiments, driver 426 includes a torque limiting area 430 that shears off head 428 once an appropriate level of torque and, thus clamping force, has been applied to device 410. In some embodiments, driver 426 can include a second head 428-2 that remains after shearing at torque limiting area 430 so that device 410 can be loosened or removed after an initial installation.

Assembly 424 includes driver retaining structures 432, 434 on opposite sides of housing 416 that allows driver 326 to rotate within the housing about driver axis D_{A} but prevents the driver from moving linearly along the driver axis D_{A}.

In the illustrated embodiment, driver retaining structure 432 on the side of housing 416 opposite head 428 is illustrated as a washer or bushing on hub 418 and a snap ring (not shown) on driver 426. In the illustrated embodiment, retaining structure 434 on the side of housing 416 proximate head 428 is illustrated as a shoulder defined on driver 426 and washer or bushing between hub 418 and the shoulder. It should be recognized that retaining structures 432, 434 are illustrated by way of example only and that any retaining structure sufficient to secure assembly 424 in housing 416 in a manner that allows driver 426 to rotate within housing 416 but prevent the driver from moving linearly along the driver axis D_{A} is contemplated by the present disclosure.

Assembly 424 further includes a driving wedge (not shown) and a ram 448, 450 in each leg 420, 422. The driving wedges are threadably engaged with the driver 426 so that the wedges move within hub 418 along driver axis D_{A} during rotation of driver 426.

Assembly 424 includes one or more jaws (two shown) 456, 458 in each leg 420, 422.

Jaws 456, 458 are configured to move linearly along the conductor axis and are retained by one or more jaw retainers 460-2 (two shown) that extend partially around legs 420, 422, respectively, to retain the jaws in the legs while allowing the jaws to move along the conductor axis.

Jaws 456, 458 can be include cooperating synchronization features 488-1, 488-2. In the illustrated embodiment, feature 488-1 is shown as a protrusion and feature 488-2 is shown as a corresponding indentation. In this manner, jaws 456, 458 are configured, when features 488-1 are received in features 488-2, to move in unison along conductor axis C_{A}.

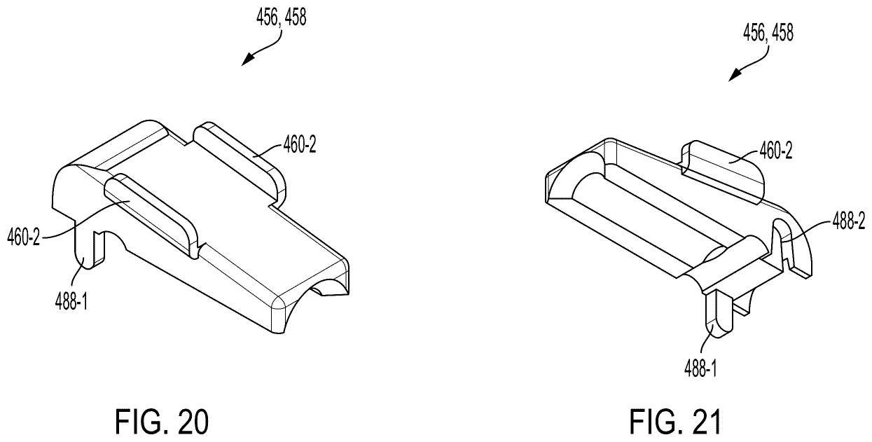

As shown in FIGS. 20-21, retainers 460-2 and features 488-1, 488-2 are integrally formed with jaws 456, 458. For example and in some embodiments, jaws 456, 458 are identical to one another and are formed as a single aluminum casting that requires no post casting machining.

In some embodiment, device 410 includes a biasing member 470 disposed between rams 448, 450 and jaws 456, 458. Biasing member 470 can be captured by spring lands (not shown) of the jaws and rams to provide a first degree of freedom that allows device 410 to accommodate conductors of differing outer diameters.

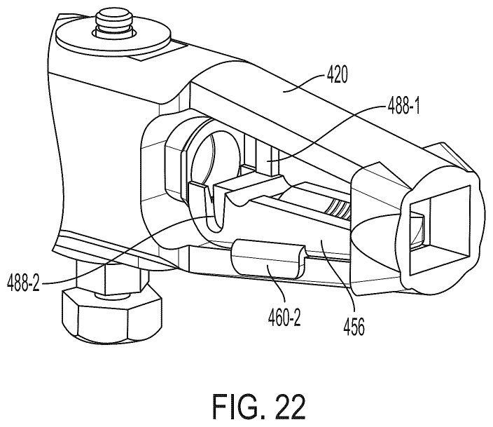

It has been further found by the present disclosure that biasing member 470 can aid in assembly of device 410, which is described in more detail with respect to FIGS. 22-25b.

Starting with FIG. 22, the assembly of device 410 begins with securing driver 426, the driving wedges, and rams 448, 450 in each leg 420, 422 of main housing 418. Jaw 456 is positioned in leg 420 with retainers 460-2 around the lower portion of leg. With jaw 456 in this position, features 488-1, 488-2 are on opposite sides of leg 420.

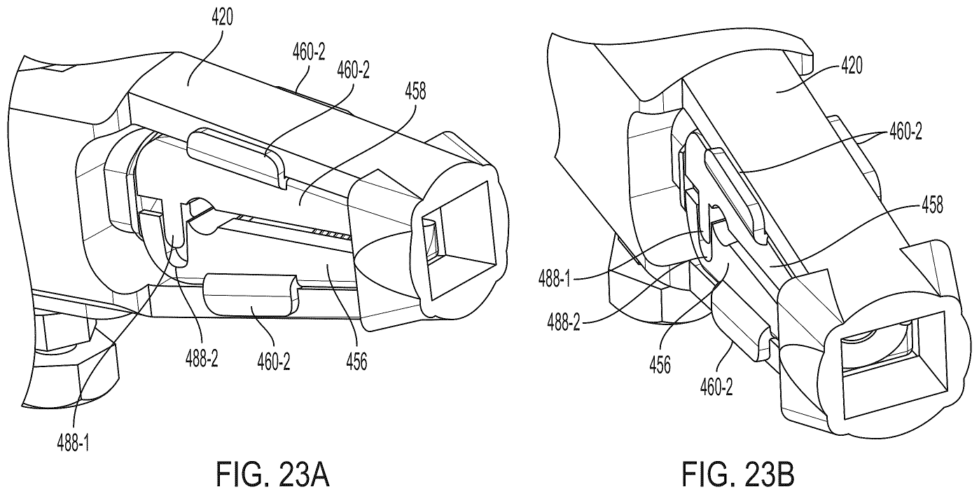

As shown in FIGS. 23a-23b, jaw 458 is then positioned in leg 420 inverted with respect to jaw 456. In this position, retainers 460-2 of jaw 458 are around the upper portion of leg 420. Since jaw 458 is inverted with respect to jaw 456, feature 488-1 of jaw 456 is received in feature 488-2 of jaw 458 and feature 488-1 of jaw 458 is received in feature 488-2 of jaw 456.

Device 410 is configured so that the shape and dimensions of legs 420, 422 and jaws 456, 458 are such that both two jaws can be positioned in each of legs 420, 422, respectively. To assist during installation of jaws 456, 458, the jaws can be positioned proximate hub 418.

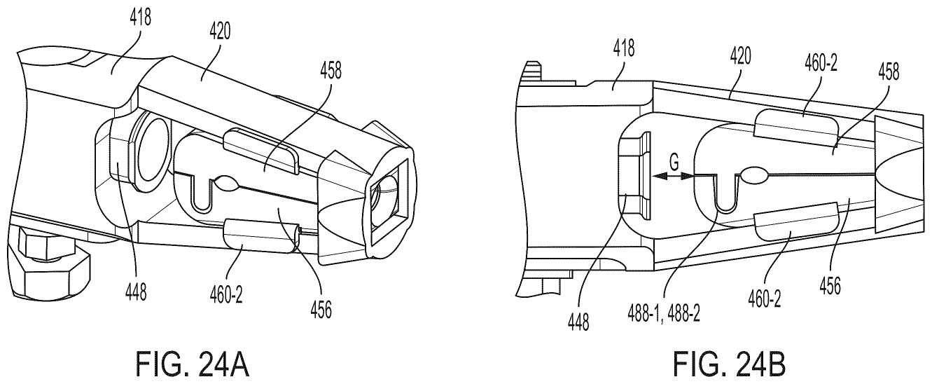

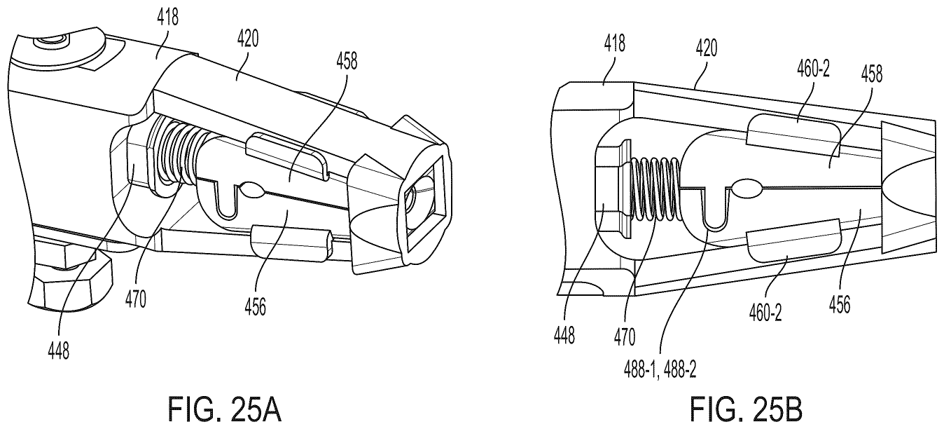

Next and as shown in FIGS. 24a-24b, jaws 456, 458 are moved within leg 420 outward away from hub 418 to provide a gap (G) between the jaws and ram 448. Device 410 is configured so that biasing member 470 is compressible to a dimension smaller than gap (G). In this manner and as shown in FIGS. 25a-25, biasing member 470 can be positioned on the spring seats of ram 448 and jaws 456, 458, respectively. Once biasing member 470 is released, the interaction of the biasing member, retainers 460-1, 460-2, and features 488-1, 488-2 are sufficient to maintain jaws 456, 458 in the desired position within leg 420.

In some embodiments, jaws 456, 458 alone or in combination with one another are configured to define a window 480. When installing the conductors into device 410, window 480 provides the user with a visual indication that the conductors are properly positioned within jaws 456, 358—without previously measuring and marking the conductor ends.

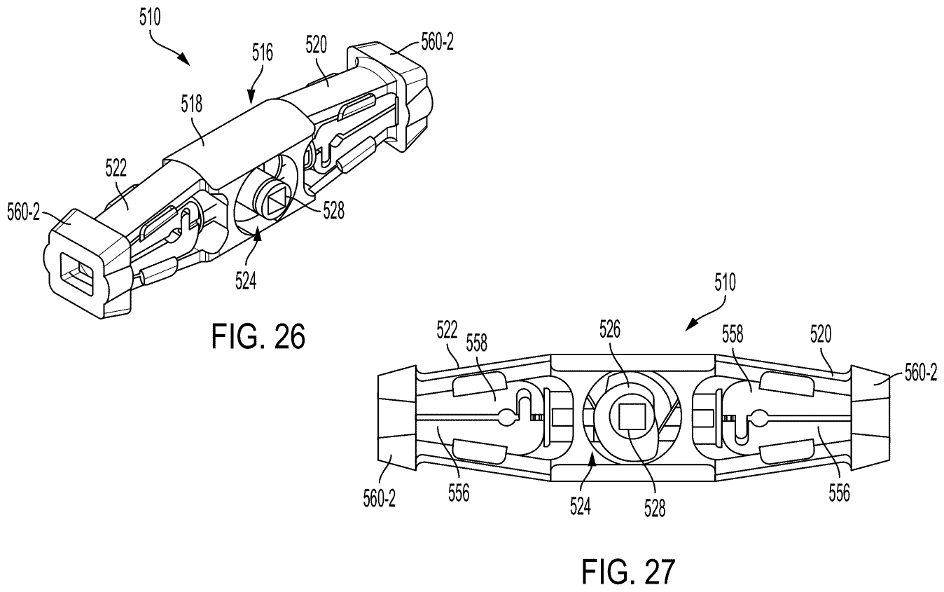

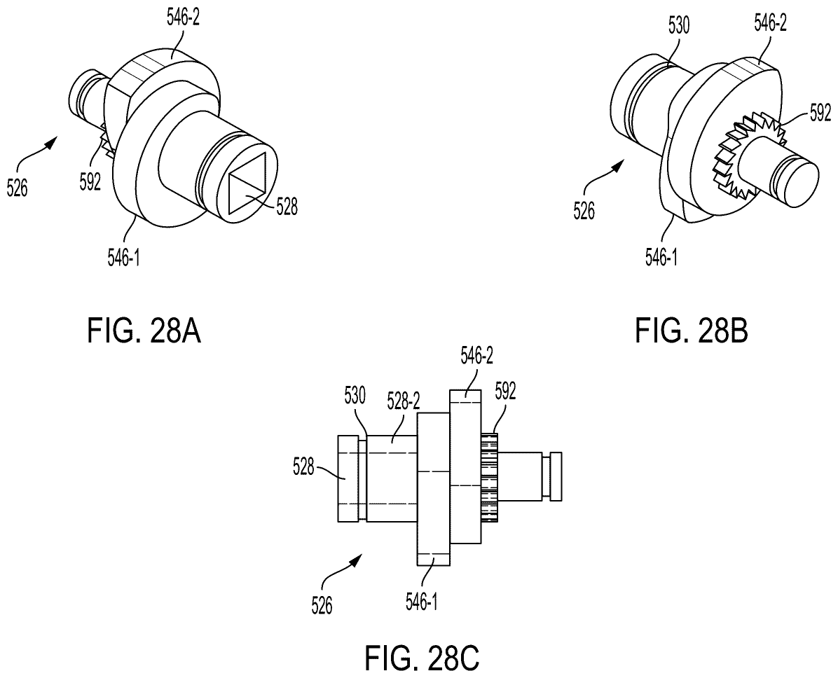

Referring now to FIGS. 26-28c, an alternate embodiment of an electrical conductor splice device according to the present disclosure is shown and is generally referred to by reference numeral 510.

Device 510 is similar to devices 10 and 410 discussed in detail above so that certain parts performing similar or analogous functions to those devices have been omitted for ease of discussion.

In some embodiments, device 510 can include structural features 560-2 around an outside of main housing 516 at ends of legs 520, 522. In some embodiments, structural features 560-2 can be cast as one piece with housing 516. In other embodiments, structural features 560-2 can be removably connected to housing 516.

Device 510 includes a movement conversion assembly 524 that has a driver 526 that differs from drivers 26, 426 discussed above. For example, devices 10, 410 are disclosed by way of example only having driver 26, 426 positioned so that driver axis D_{A} has a vertical orientation. In contrast, device 510 is configured so that driver axis D_{A} has a horizontal orientation.

In the illustrated embodiment, driver 526 is shown as a squared opening 528, which is sized and configured to receive the drive of a socket wrench in a known manner. Here, driver 526 can include a torque limiting region 530 that shears off opening 528 once an appropriate level of torque and, thus clamping force, has been applied to device 510.

In some embodiments, driver 526 can include, when region 530 is present, a second opening 528-2 so that when the torque limiting region shears off, the second opening remains so that device 510 can be loosened or removed after an initial installation.

Furthermore, devices 10, 410 are disclosed by way of example only having driver 26, 426 that is configured as a bolt threadably engaged with driving wedges 46, 446 that act on rams 48, 50, 448, 450. Device 510 includes a one-piece structure that includes driver 526 and two cam lobes 546-1, 546-2

During application of a tightening movement on driver 526, rams 548, 550 act as cam followers on lobes 546-1, 546-2 to convert the tightening motion into linear motion of jaws 556, 558. Lobes 546-1, 546-2 can be separate from one another as illustrated or can be defined by two-profiles in the same lobe.

Assembly 524 includes releasable locking structure that can maintain the driver in a tightened position. In some embodiments, locking structure is ratchet that includes a gear 592 and a pawl (not shown). In some embodiments, the pawl can be released from gear 592 so that device 510 can be loosened or removed after an initial installation.

It should be recognized that device 510 is shown having driver 526 configured with squared opening 528. Of course, it is completed by the present disclosure for driver 526 to be configured as any torque receiving structure such as but not limited to, a bolt head as disclosed with devices 10, 410, flat head drives, Phillips drives, hex drives, Torx drives, square drives openings, and others.

It should also be recognized that device 510 is shown having driver 526 configured with cam lobes 546-1, 546-2 positioned with driver axis D_{A} in a horizontal orientation. Of course, it is completed by the present disclosure for device 510 to be configured with cam lobes 546-1, 546-2 having the driver axis D_{A} in the vertical orientation.

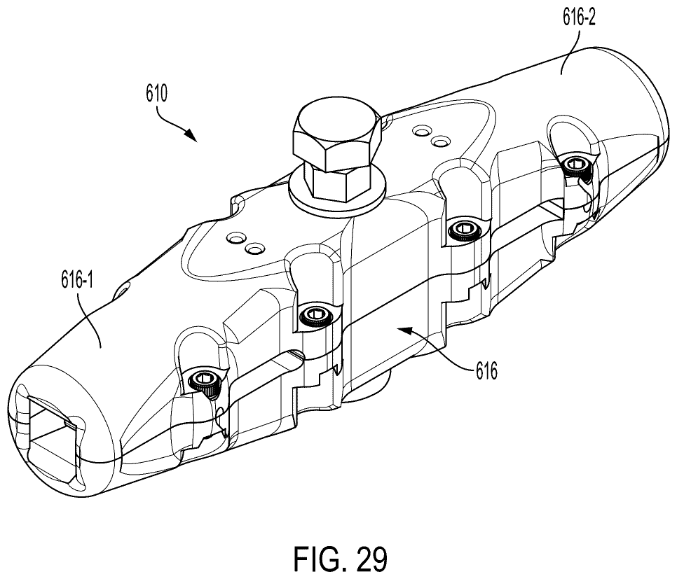

Referring now to FIGS. 29-31, another alternate embodiment of an electrical conductor splice device according to the present disclosure is shown and is generally referred to by reference numeral 610. Device 610 is similar to device 310 discussed above. Specifically, device 610 is configured as an enclosed splice device having an outer housing 616 that takes the place of the main housing 16, the hub 18, the legs 20, 22, and the jaw retainers 60-1, 60-2.

Housing 616 is formed in multiple sections that are connected to one another in any desired manner such as, but not limited to, mechanical connection, thermal connection, adhesive connection, and others. For example and as shown in the illustrated embodiment, housing 616 has two sections 616-1, 616-2 that are mechanically connected to one another by way of bolts. Of course, it is contemplated for other mechanical connections to secure sections 616-1, 616-2 to one another such as rivets, screws, and other mechanical connectors.

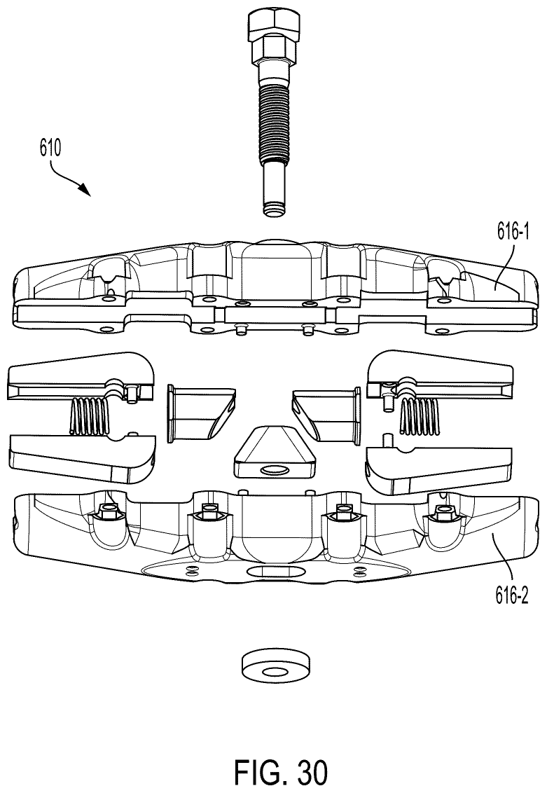

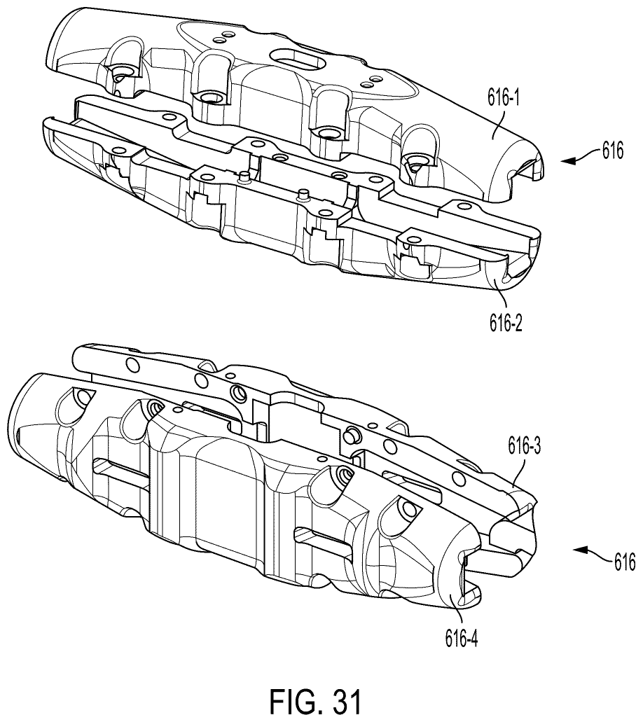

In FIG. 30, housing 616 has sections 616-1, 616-2 that mate along a horizontal plane. Of course it is contemplated by the present disclosure for housing 616 to have sections 616-3, 616-4 that mate along a vertical plane as shown in FIG. 31 side-by-side comparison with sections 616-1, 616-2. Moreover, it is contemplated by the present disclosure for housing 616 to have any desired number of sections that are mated along any desired number or oriented planes.

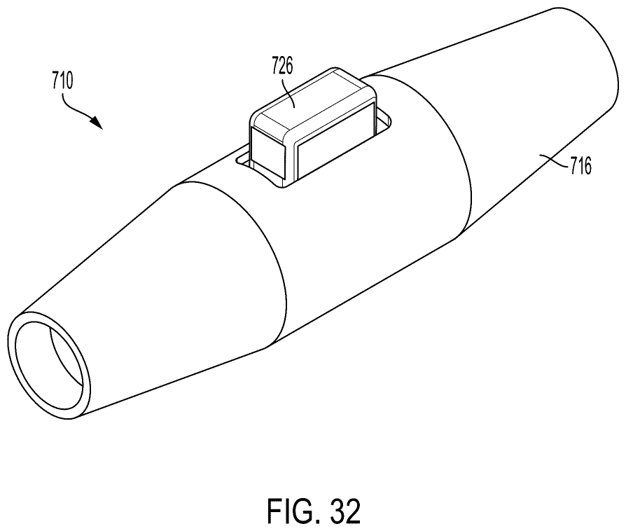

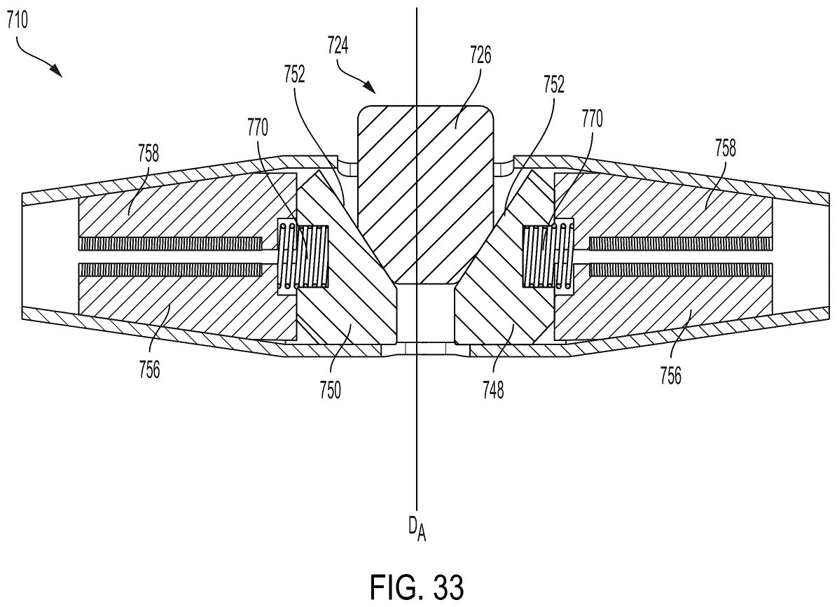

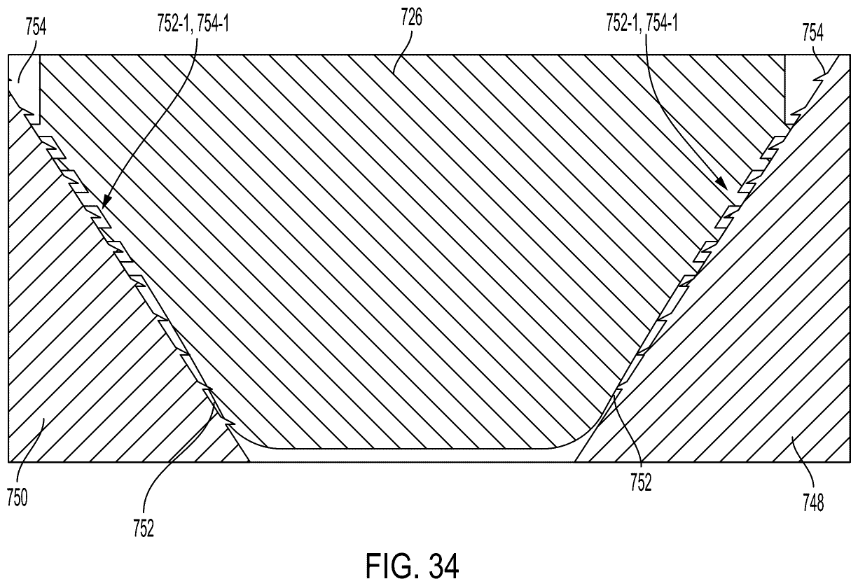

Referring now to FIGS. 32-34, another alternate embodiment of an electrical conductor splice device according to the present disclosure is shown and is generally referred to by reference numeral 710.

Device 710 is configured as an enclosed splice device having an outer housing 716 that takes the place of the main housing, the hub, the legs, and the jaw retainers of other embodiments. Rather, device 710 includes movement conversion assembly 724 contained within housing 716.

Housing 716 can be formed in multiple sections that are connected to one another in any desired manner such as, but not limited to, mechanical connection, thermal connection, adhesive connection, and others.

Additionally, housing 716 can be formed as a unitary hollow element that has one or more regions compressed around components of device 710. For example and as shown in the illustrated embodiment, housing 716 has ends that are swaged around the components of device 710.

Device 710 includes movement conversion assembly 724 that is configured so that the tightening movement is a pressing or compression movement of a driver 726 vertically downward. However, it should be recognized that tightening movements that are vertically upward pressing or compressing of driver 726, horizontal pressing or compressing of the driver, or any desired combination of these directions are all contemplated by the present disclosure.

Device 710 is shown having certain components omitted for ease of discussion. For example, device 710 is shown without driver retaining structures on housing 716 that allows the driver 727 to move within the housing along driver axis D_{A} but prevents the driver from falling out of the housing.

The pressing or compressing movement can be provided in any desired manner including, but not limited to, hammering on driver 726, pushing on the driver using a clamp, pushing on the driver using a tool (e.g., plyers), and others.

Movement conversion assembly 724 includes driver 726 but eliminates the wedge of prior embodiments disclosed herein by inclusion of angled driving surface 752 on the driver itself. Movement conversion assembly 724 can in some embodiments further include rams 748, 750 that each have an angled driven surface 754.

The pressing or compression tightening movement of driver 726 is converted, by the interaction of surfaces 752, 754 with one another, into movement of rams 748, 750 outward along the conductor axis C_{A}, which in turn results in movement of jaws 756, 758 applying the clamping force C_{F} on the conductors in the manner described in detail above.

Movement conversion assembly 724 can be configured to maintain the pressed or compressed position of driver 726 in any desired manner.

In the illustrated embodiment, driving surface 752 includes a plurality of teeth 752-1 and driven surface 754 includes a corresponding plurality of teeth 754-1. During use, teeth 752-2, 754-1 can slide over one another during the pressing or compression of driver 726 but prevent the driver from backing away from the tightened position. In some embodiments, the interaction of teeth 752-2, 754-1 can be released so that movement conversion assembly 724 can be loosened or removed after an initial installation of device 710.

In other illustrated embodiments, device 710 can include clamp (not shown) that tightens around housing 716 to press or compress driver 726. The clamp can, in some embodiments, retain driver 726 in housing 716 and can cover or seal the housing.

Movement conversion assembly 724 can, in some embodiments, further include biasing member 770 disposed between rams 748, 750 and jaws 756, 758. Biasing member 770 can be captured by spring lands (not shown) of the jaws and rams to provide a first degree of freedom that allows device 710 to accommodate conductors of differing outer diameters.

It should be recognized that device 710 can be further modified to conform to the design of device 310 shown in FIGS. 15b-15c. For example, it is contemplated for device 710 to have jaws 758, 760 integrally formed with the rams, namely to include driven surface 754 and teeth 754-1 directly on the jaws, to move biasing member 770 outward of driver 726, and to rotate the jaws with respect to the driver so that each jaw has a continuous angled surface in contact with the angled surfaces 752 of the driver.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### PARTS LIST

splice device 10
electrical conductors 12, 14
main housing 16
hub 18
legs 20, 22
conversion assembly 24
driver 26
driver axis D_{A}
heads 28, 28-2
torque limiting area 30
retaining structures 32, 34
cap 36
washer or bushing 38
snap ring 40
shoulder 42
washer or bushing 44
driving wedge 46
ram 48, 50
angled surfaces 52, 54
conductor axis C_{A}
jaws 56, 58
jaw retainers 60-1, 60-2
pushed/pushing surfaces 62, 64
inner/outer surfaces 66, 68
biasing member 70
spring lands 72, 74
gaps 76, 78
gaps 76-1, 78-1
window 80
stop 82
edges 84, 86
conversion assembly 24-1
dead-end 22-1
splice device 110
conductors 112, 114
housing 116
rams 148, 150
jaws 156, 158
driver 126
driving wedge 146
biasing member 170
splice device 210
conductors 212, 214
housing 216
rams 248, 250
jaws 256, 258
drivers 226
biasing member 270
splice device 310
outer housing 316
jaws 358, 360
angled surfaces 352, 354
biasing member 370
splice device 410
main housing 416
hub 418
legs 420, 422
structural features 460-1
conversion assembly 424
driver 426
heads 428, 428-2
torque limiting area 430
retain structures 432, 434
ram 448, 450
jaws 456, 458
jaw retainers 460-2
features 488-1, 488-2
biasing member 470
gap (G)
window 480
splice device 510
legs 520, 522
conversion assembly 524
driver 526
openings 528, 528-2
torque limiting region 530
cam lobes 546-1, 546-2
rams 548, 550
jaws 556, 558
structural features 560-2
covers 560-3
gear 592
splice device 610
outer housing 616
sections 616-1, 616-2
sections 616-3, 616-4
splice device 710
outer housing 716
conversion assembly 724
driver 726
angled driving surface 752
rams 748, 750
angled driven surface 754
teeth 752-1, 754-1
jaws 756, 758
biasing member 770

What is claimed is:

1. An electrical conductor splice device, comprising:
a main housing;
a first set of jaws in the main housing and depending outward along a conductor axis, the first set of jaws being configured to receive a first electrical conductor therein; and
a movement conversion assembly in the main housing, the movement conversion assembly including a driver operatively associated with the first set of jaws so that a tightening movement of the driver is converted into a clamping force of the first set of jaws on the first electrical conductor.

2. The splice device of claim 1, wherein the tightening movement is rotary movement of the driver about a driver axis or a linear movement of the driver along the driver axis.

3. The splice device of claim 1, further comprising a dead-end depending from the main housing.

4. The splice device of claim 1, further comprising a second set of jaws in the main housing and depending outward along the conductor axis, the movement conversion assembly being operatively associated with the second set of jaws so that the tightening movement of the driver is converted into a second clamping force of the second set of jaws on the second electrical conductor to mechanically and electrically connect the second electrical conductor.

5. The splice device of claim 4, wherein the movement conversion assembly is configured to move along the conductor axis during the tightening movement of the driver so as to accommodate differences in diameter of the first and second electrical conductors.

6. The splice device of claim 5, wherein the first and second set of jaws move along the conductor axis independent of one another or in unison.

7. The splice device of claim 4, wherein the main housing encloses the first and second set of jaws and the movement conversion assembly.

8. The splice device of claim 7, wherein the main housing is a unitary member that is compressed onto the first and second set of jaws and the movement conversion assembly.

9. The splice device of claim 7, wherein the main housing comprises a first section and a second section that are bolted together.

10. The splice device of claim 1, further comprising a gap between the driver and the main housing, the gap being configured to allow the movement conversion assembly to move along the conductor axis during the tightening rotary movement of the driver so as to accommodate differences in diameter of the first electrical conductor.

11. The splice device of claim 1, further comprising a biasing member configured to provide an initial clamping force on the first set of jaws prior to the tightening rotary movement of the driver.

12. An electrical conductor splice device, comprising:
a main housing having a hub, a first leg, and a second leg, the first and second legs depending outward from the hub along a conductor axis;
a first set of jaws positioned in the first leg, the first leg being configured to receive a first electrical conductor therein;
a second set of jaws positioned in the second leg, the second leg being configured to receive a second electrical conductor therein; and
a movement conversion assembly within the hub and including a driver, wherein the movement conversion assembly is operatively associated with the first and second set of jaws to convert a tightening movement of the driver into a linear outward movement of the first and second set of jaws along the conductor axis,
wherein the first and second legs each have an inner surface that interact with an outer surface of the first and second set of jaws, respectively, to convert the linear outward movement of the first and second set of jaws into a clamping movement to impart a clamping force on the first and second electrical conductors to mechanically and electrically connect the first and second electrical conductors, respectively.

13. The splice device of claim 12, wherein the tightening movement is rotary movement of the driver about a driver axis or a linear movement of the driver along the driver axis.

14. The splice device of claim 12, wherein the movement conversion assembly is configured to move along the conductor axis during the tightening movement of the driver so as to accommodate differences in diameter of the first and second electrical conductors.

15. The splice device of claim 14, wherein the first and second set of jaws move along the conductor axis independent of one another or in unison.

16. The splice device of claim 14, further comprising a gap between the movement conversion assembly and the main housing, the gap being configured to allow the movement conversion assembly to move along the conductor axis during the tightening movement of the driver.

17. The splice device of claim 12, wherein the movement conversion assembly comprises a driving wedge, a first ram, and a second ram that are configured to convert a tightening movement of the driver into the linear outward movement of the first and second rams along the conductor axis,
wherein the linear outward movement of the first ram along the conductor axis results in linear outward movement of the first set of jaws and the linear outward movement of the second ram along the conductor axis results in linear outward movement of the second set of jaws.

18. The splice device of claim 12, further comprising:
a first biasing member positioned between the first ram and the first set of jaws; and
a second biasing member positioned between the second ram and the second set of jaws.

19. The splice device of claim 18, wherein the first and second biasing members are configured to provide an initial clamping force on the first and second set of jaws prior to the tightening movement of the driver.

20. The splice device of claim 12, wherein the movement conversion assembly is configured to mechanically and electrically connect the first and second conductors when the first and second conductors have a common outer diameter or different outer diameters.

21. The splice device of claim 12, wherein the movement conversion assembly is configured to mechanically and electrically connect the first and second conductors when the first and second conductors are under tension or are not under tension.

22. The splice device of claim 12, wherein the driver further comprises a torque limiting area that shears off a portion of the driver at a desired torque to ensure the clamping force has been applied to the first and second electrical conductors.

23. The splice device of claim 12, wherein the first set of jaws comprise a first window that provides a visual confirmation of a position of the first electrical conductor within the first set of jaws and/or the second set of jaws comprise a second window that provides a visual confirmation of a position of the second electrical conductor within the second set of jaws.

24. The splice device of claim 12, wherein the first set of jaws comprise a first conductor stop that provides a tactile indication of a position of the first electrical conductor within the first set of jaws and/or the second set of jaws comprise a second conductor stop that provides a tactile indication of a position of the second electrical conductor within the second set of jaws.
